(19) United States
(12) Patent Application Publication
(10) Pub. No.: US 2018/0367202 A1
(43) Pub. Date: Dec. 20, 2018

(54) Codeword Mapping In NR And Interleaver Design For NR

(71) Applicant: MediaTek Inc., Hsinchu City (TW)

(72) Inventors: Weidong Yang, San Diego, CA (US); Tzu-Han Chou, San Jose, CA (US); Ju-Ya Chen, Hsinchu City (TW); Lung-Sheng Tsai, Hsinchu City (TW)

(21) Appl. No.: 16/010,458

(22) Filed: Jun. 16, 2018

Related U.S. Application Data
(63) Continuation-in-part of application No. 15/952,661, filed on Apr. 13, 2018.
(60) Provisional application No. 62/521,218, filed on Jun. 16, 2017.
(60) Provisional application No. 62/527,013, filed on Jun. 29, 2017.
(60) Provisional application No. 62/544,076, filed on Aug. 11, 2017.

(51) Int. Cl. H04B 7/06; H04L 1/18; H04L 1/00

(52) U.S. Cl. CPC H04B 7/0639; H04L 1/0071; H04B 7/063; H04L 1/1812

(57) ABSTRACT

Techniques and examples pertaining to codeword mapping in New Radio (NR) and interleaver design for NR are described. A processor of an apparatus receives, via a transceiver of the apparatus, a Physical Downlink Shared Channel (PDSCH) transmission from a network node of a wireless network. The processor maps one or more codeblocks of a codeword in the PDSCH transmission to a spatial layer group which is a subset of a plurality of spatial layers. The processor also performs receive processing for one or more codeblocks in the PDSCH transmission including by performing de-interleaving on a result from a channel interleaver or from an intra-codeblock interleaver that performs pseudo-random interleaving on systematic bits and parity bits of the one or more codeblocks and channel decoding. The processor transmits, via the transceiver, to the network node a feedback concerning the one or more codeblock and reporting a result of the channel estimation.

### CROSS REFERENCE TO RELATED PATENT APPLICATION

The present disclosure claims the priority benefit of U.S. Provisional Patent Application No. 62/521,218, filed 16 Jun. 2017, U.S. Provisional Patent Application No. 62/527,013, filed 29 Jun. 2017, and U.S. Provisional Patent Application No. 62/544,076, filed 11 Aug. 2017. The present disclosure is also part of a Continuation-in-Part (CIP) of U.S. patent application Ser. No. 15/952,661 filed 13 Apr. 2018. The contents of aforementioned applications are herein incorporated by reference in their entirety.

### TECHNICAL FIELD

The present disclosure is generally related to mobile communications and, more particularly, to codeword mapping in New Radio (NR) and interleaver design for NR.

### BACKGROUND

Unless otherwise indicated herein, approaches described in this section are not prior art to the claims listed below and are not admitted as prior art by inclusion in this section.

In 5^{th} Generation (5G) New Radio (NR) networks, multi-user multiple-input-and-multiple-output (MU-MIMO) transmissions can be subject to cross-link interference (CLI). For persistent CLI, regular MIMO transmission strategies to cope with the CLI may be sufficient. However, for bursty CLI, there has yet to be a MIMO transmission strategy to achieve robustness when CLI is present and achieve high throughput when CLI is absent.

Additionally, regular codeword layer mapping as in NR tends to suffer from a number of issues. For example, there can be inefficient transmission as damaged codeblock leads to retransmission of a whole codeword. As another example, if a Long-Term Evolution (LTE)-like codeword layer mapping is used (e.g., two codewords for four layers with each codeword for two layers), and codeblock group-based hybrid automatic repeat request (HARQ) feedback is used, then feedback can still be inefficient.

Moreover, fixed correspondence with the first [L/2] layers mapped to codeword CW0 and remaining layers mapped to codeword CW1 is a simple scheme. However, in some cases (e.g., multi-transmission and reception point (TRP) transmissions or dynamic time-division duplexing (TDD) with low rank CLI), link quality varies significantly from layer to layer. To leverage better link adaption by multiple codewords, a base station (e.g., gNB or TRP) can configure a user equipment (UE) to use variable correspondence for some scenarios (e.g., cell edge users in small cell environment) that allows the UE to report preferred layer set for CW0, with the remaining layers mapped to CW1. In NR, fixed resource element (RE) mapping order, which has lower latency advantage, is adopted but potential gain from time diversity can be missed. Besides, it remains a challenge to achieve low processing latency while harvest frequency diversity gain simultaneously.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of an apparatus receiving a Physical Downlink Shared Channel (PDSCH) transmission from a network node of a wireless network. The method may also involve the processor mapping one or more codeblocks of a codeword in the PDSCH transmission to a spatial layer group which is a subset of a plurality of spatial layers. The method may further involve the processor transmitting to the network node a feedback concerning the one or more codeblocks.

In one aspect, a method may involve a processor of an apparatus receiving a PDSCH transmission from a network node. The method may also involve the processor performing receive processing for one or more codeblocks in the PDSCH transmission including by performing de-interleaving on the result from channel interleaver and/or from an intra-codeblock interleaver that performs pseudo-random interleaving on systematic bits and parity bits of the one or more codeblocks and channel decoding. The method may further involve the processor transmitting to the network node a feedback reporting a result of the receive processing.

In one aspect, an apparatus may include a transceiver and a processor communicatively coupled to the transceiver. The transceiver may be capable of wirelessly communicating with a network node of a wireless network. The processor may be capable of the following: (1) receiving, via the transceiver, a PDSCH transmission from the network node; (2) mapping one or more codeblocks of a codeword in the PDSCH transmission to some but not all spatial layers of a plurality of spatial layers; (3) performing receive processing for the one or more codeblocks by utilizing an intra-codeblock interleaver that performs pseudo-random interleaving on systematic bits and parity bits of the one or more codeblocks; and (4) transmitting, via the transceiver, to the network node over one or more OFDM symbols a feedback comprising the codeblock and reporting a result of the receiving processing.

It is noteworthy that, although description of the proposed scheme and various examples is provided below in the context of 5G NR wireless communications, the proposed concepts, schemes and any variation(s)/derivative(s) thereof may be implemented in communications in accordance with other protocols, standards and specifications where implementation is suitable. Thus, the scope of the proposed scheme is not limited to the description provided herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example codeblock mapping over an orthogonal frequency-division multiplexing (OFDM) symbol 0 in accordance with an implementation of the present disclosure.

FIG. 2 is a diagram of an example codeblock mapping over an OFDM symbol 1 in accordance with an implementation of the present disclosure.

FIG. 3 is a diagram of an example scenario of frequency-time interleaving with different parameters in accordance with an implementation of the present disclosure.

FIG. 4 is a diagram of an example scenario of codeblock partitioning in accordance with an implementation of the present disclosure.

FIG. 5 is a diagram of an example communications system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to mobile country code recognition with respect to user equipment in mobile communications. According to the present disclosure, a number of possible solutions may be implemented separately or jointly. That is, although these possible solutions may be described below separately, two or more of these possible solutions may be implemented in one combination or another.

### Codeword Mapping in NR

Interference in NR can be more dynamic than in LTE for a variety of reasons. The network not having prior knowledge of the CLI at a UE would experience the CLI especially when the network operates with single-cell scheduling. An analysis of the effect of CLI on MIMO transmissions is provided below, considering a MIMO transmission over two spatial layers. In this analysis, a receiver model is represented by Expression (1) below.

$$r = \underbrace{{HP}_{1}}_{{H}_{1}} {x}_{1} + \underbrace{{HP}_{2}}_{{H}_{2}} {x}_{2} + {G}_{0} y + n , \qquad ( 1 )$$

Here, H denotes the channel response between a base station and a UE, Hₖ denotes the effective channel response including precoder Pₖ for xₖ, G₀ denotes the channel response including possible precoder for interfering signal y, and ₙ denotes a spatially white noise with standard deviation at 1.

In the setup of dynamic TDD, y is often an uplink signal from a UE near the UE of interest rather than a downlink signal from another cell as found in conventional interference scenarios. In other words, y is due to CLI.

With a minimum mean square error (MMSE)-interference rejection combining (IRC) receiver, the signal-to-interference-plus-noise ratio (SINR) for x₁ is derived by Expression (2) below.

$$\underbrace{{SINR}_{1}}_{SINR for {x}_{1}} = \vert {H}_{1} {\vert}^{2} - \frac{\vert {H}_{1}^{H} {G}_{0} {\vert}^{2}}{\vert {G}_{0} {\vert}^{2} + 1} - \frac{\vert {H}_{1}^{H} {H}_{2} - \frac{{H}_{1}^{H} {G}_{0} {G}_{0}^{H} {H}_{2}}{\vert {G}_{0} {\vert}^{2} + 1} {\vert}^{2}}{\vert {H}_{2} {\vert}^{2} - \frac{\vert {H}_{2}^{H} {G}_{0} {\vert}^{2}}{\vert {G}_{0} {\vert}^{2} + 1} + 1} \qquad ( 2 )$$

The signal level of CLI y can be much higher than that for xₖ. Let the following factorization stand: (1) G₀=g₀G, where g₀≥0, and G is a vector of unit norm; (2) H₁=a₁U+b₁G, with a₁≥0 for a properly chosen U, and U is a vector of unit norm and U⊥G; (3) H₂=a₂U+b₂G+cV, with c≥0 for a properly chosen unit vector V, V⊥U, and V⊥U for more than two receivers. When two receivers are used at the UE, V does not exist, and for the formulas below it can be assumed that c=0.

With the factorization above, the channel responses for different layers can be expressed in Expression (3) below as a sum of projections along the interferer's channel response and vectors orthogonal to that channel response.

$$\begin{matrix}{SINR}_{1} = \vert {H}_{1} {\vert}^{2} - \frac{\vert {b}_{1} {g}_{0} {\vert}^{2}}{\vert {G}_{0} {\vert}^{2} + 1} + \frac{\vert {a}_{1}^{*} {a}_{2} + {b}_{1}^{*} {b}_{2} - \frac{{b}_{1}^{*} {g}_{0} {g}_{0}^{*} {b}_{2}}{\vert {G}_{0} {\vert}^{2} + 1} {\vert}^{2}}{\vert {H}_{2} {\vert}^{2} - \frac{\vert {g}_{0} {b}_{2} {\vert}^{2}}{\vert {G}_{0} {\vert}^{2} + 1} + 1} \\ = \vert {H}_{1} {\vert}^{2} - \frac{\vert {b}_{1} {g}_{0} {\vert}^{2}}{\vert {G}_{0} {\vert}^{2} + 1} - \frac{\vert {a}_{1}^{*} {a}_{2} + \frac{{b}_{1}^{*} {b}_{2}}{\vert {G}_{0} {\vert}^{2} + 1} {\vert}^{2}}{\vert {H}_{2} {\vert}^{2} - \frac{\vert {g}_{0} {b}_{2} {\vert}^{2}}{\vert {G}_{0} {\vert}^{2} + 1} + 1} \\ \approx \vert {H}_{1} {\vert}^{2} - \vert {b}_{1} {\vert}^{2} - \frac{\vert {a}_{1} {a}_{2} {\vert}^{2}}{\vert {H}_{2} {\vert}^{2} - \vert {b}_{2} {\vert}^{2} + 1} when {g}_{0} is very large \\ = {a}_{1}^{2} - \frac{\vert {a}_{1} {a}_{2} {\vert}^{2}}{\vert {a}_{2} {\vert}^{2} + {c}^{2} + 1} \\ = \frac{{a}_{1}^{2} ( {c}^{2} + 1 )}{\vert {a}_{2} {\vert}^{2} + {c}^{2} + 1}\end{matrix} \qquad ( 3 )$$

With two receivers at the UE, the condition represented by Expression (4) below stands.

$${SINR}_{1} = \frac{{{a}_{1}^{2}}_{\begin{matrix}⏟ \\ 〈 \vert {H}_{1} , U 〉 {\vert}^{2} \text{:} projectionof {x}_{1} along a subspace ( U ) orthogonalto G\end{matrix}}}{{\vert {a}_{2} {\vert}^{2}}_{\begin{matrix}⏟ \\ 〈 \vert {H}_{2} , U 〉 {\vert}^{2} \text{:} projectionof {x}_{2} along a subspace ( U ) orthogonalto G\end{matrix} + 1}} . \qquad ( 4 )$$

Similarly, in general the condition represented by Expression (5) below stands.

$$\begin{matrix}{SINR}_{2} = ( \vert {a}_{2} {\vert}^{2} + {c}_{2} ) - \frac{\vert {a}_{1} {a}_{2} {\vert}^{2}}{{a}_{1}^{2} + 1} \\ = \frac{\vert {a}_{2} {\vert}^{2}}{{a}_{1}^{2} + 1} + {c}^{2}\end{matrix} \qquad ( 5 )$$

With two receivers, the condition represented by Expression (6) below stands.

$${SINR}_{2} = \frac{\vert {a}_{2} {\vert}^{2}}{{a}_{1}^{2} + 1} . \qquad ( 6 )$$

From the above derivation, it can be seen that with the presence of a strong interfering signal, the effect of the MMSE-IRC weight is to project the received signals to a direction perpendicular to the interfering signal's channel response G. It can also be seen that for higher ranks, a similar behavior can be observed. That is, the received signals are projected into a subspace orthogonal to the subspace spanned by the channel responses of the interfering signals.

As Hₖ is a composite of H and Pₖ, what the projections at the receiver will be can be controlled. In other words, a₁ and a₂ can be controlled through the choice of Pₖ.

For transmission of L layers, the number of combination is

$${Σ}_{i = 1}^{⌊ L \text{/} 2 ⌋} ( \begin{matrix}L \\ i\end{matrix} ) .$$

In the case of L=8, a total of 162 combinations may result. In case layer 1 is allowed to always go to CW0, the number is reduced to 63. To further reduce the number of combinations for selection, a couple of alternatives may be utilized.

Under a proposed scheme in accordance with the present disclosure, a first alternative may involve mapping the first L₀ layers (L₀∈{1,2,3,4}) to CW0, with the remaining layers mapped to CW1. With this approach, the UE may attempt to separate set {1 . . . L} into two contiguous parts that group dominated interference layers in one chunk. Under the proposed scheme, a second alternative may involve paring each of two layers to form a reduced set of ┌L/2┐ elements. The UE may report the preferred layers via paired index. For example, in the case of L=8, eight layers may be paired to form a set of four elements {S₁=(1,2),S₂=(3,4),S₃=(5,6),S₄=(7,8)}. The UE may indicate which pairs are preferred for CW0. The number of combinations in this example is

$$( \begin{matrix}4 \\ 1\end{matrix} ) + ( \begin{matrix}4 \\ 2\end{matrix} ) = 10.$$

Accordingly, it is believed that one of ordinary skill in the art would appreciate that, under the proposed scheme, configurable correspondence is supported to allow a UE to report preferred codeword-to-layer mapping to a base station. Moreover, the proposed alternatives may be utilized to further reduce the number of possibilities.

### Robust Transmission Strategy for Bursty CLI

To identify the optimal transmission strategy, a reasonable metric may be the sum rate for two layers. The sum rate for two layers is represented by Expression (7) below.

$${log}_{2} ( 1 + {SINR}_{1} ) + {log}_{2} ( 1 + {SINR}_{2} ) = {log}_{2} \frac{{( \vert {a}_{1} {\vert}^{2} + \vert {a}_{2} {\vert}^{2} + 1 )}^{2}}{( \vert {a}_{1} {\vert}^{2} + 1 ) ( \vert {a}_{2} {\vert}^{2} + 1 )} , \qquad ( 7 )$$

Assume P is a 2×2 unitary matrix, in general a 2×2 unitary matrix can be parameterized as shown in Expression (8) below.

$$P = [ \begin{matrix}1 & \\ & {e}^{j {φ}_{1}}\end{matrix} ] [ \begin{matrix}cos ( θ ) & sin ( θ ) \\ - sin ( θ ) & cos ( θ )\end{matrix} ] [ \begin{matrix}1 & \\ & {e}^{j {φ}_{2}}\end{matrix} ] \qquad ( 8 )$$

For P, as a precoder, it is enough to use the parameterization shown in Expression (9) below.

$$P = [ \begin{matrix}1 & \\ & {e}^{j {φ}_{1}}\end{matrix} ] [ \begin{matrix}cos ( θ ) & sin ( θ ) \\ - sin ( θ ) & cos ( θ )\end{matrix} ] . \qquad ( 9 )$$

It can be further assumed that the condition represented by Expression (10) below stands.

$$H = [ U G ] [ \begin{matrix}{d}_{11} & {d}_{12} \\ {d}_{21} & {d}_{22}\end{matrix} ] , \qquad ( 10 )$$

Here, dᵢⱼ denote complex numbers. Then, it can be checked that the condition represented by Expression (11) below stands.

a₁=d₁₁ cos(θ)−d₁₂e^{jϕ}^{₁} sin(θ)

a₂=d₁₁ sin(θ)+d₁₂e^{jϕ}^{₁} cos(θ) (11)

It can also be verified that the condition represented by Expression (12) below stands.

|a₁|²+|a₂|²=|d₁₁|²+|d₁₂|². (12)

The sum rate can be maximized with Expression (13) below.

a₁=0

|a₂|²=|d₁₁|²+|d₁₂|² (13)

In this case one solution is given by Expression (14) below.

$$cos ( θ ) = \frac{\vert {d}_{12} \vert}{\sqrt{\vert {d}_{11} {\vert}^{2} + \vert {d}_{12} {\vert}^{2}}} \\ sin ( θ ) = \frac{\vert {d}_{11} \vert}{\sqrt{\vert {d}_{11} {\vert}^{2} + \vert {d}_{12} {\vert}^{2}}} \\ {φ}_{1} = angle ( {d}_{11} {d}_{12}^{*} ) \\ P = [ \begin{matrix}1 & \\ & {e}^{j {φ}_{1}}\end{matrix} ] [ \begin{matrix}cos ( θ ) & sin ( θ ) \\ - sin ( θ ) & cos ( θ )\end{matrix} ] . \qquad ( 14 )$$

Based on the above analysis, under a proposed scheme in accordance with the present disclosure, an optimal MIMO transmission strategy may be to map a codeblock to some but not all spatial layers (e.g., a spatial layer group), and align the spatial layer group with the possible interfering signal with one or more other spatial layer groups orthogonal to the possible interfering signal. One benefit of the proposed scheme is that, due to the bursty nature of CLI, typically a scheduler (e.g., a gNB or TRP) does not have the foresight to decide whether or not a UE would experience CLI in a specific slot. Yet, from channel state information (CSI) feedback, the scheduler may acquire information about CLI, which can be put to good use. In particular, knowledge about the CLI may be used in choosing the precoder which leads to robustness in Physical Downlink Shared Channel (PDSCH) transmission to CLI and corresponding spatial layer groups for codeblock mapping. Such a mapping scheme may provide inherent robustness to CLI. For example, in case the possible interfering signal does materialize in a certain slot, then the unaffected spatial layers may still carry codeblocks which can be correctly decoded. Moreover, in case that the possible interfering signal is not present in a slot, then codeblocks carried over all spatial layers may be correctly decoded with a high probability.

Under the proposed scheme, a UE may be configured with two interference measurement resources (IMRs), namely IMR1 and IMR2, associated with one non-zero power (NZP) CSI-reference signal (RS). The first IMR (IMR1) may be for CSI with the presence of CLI. From IMR1, the UE may generate a feedback with a first precoding matrix indicator (PMI), or PMI_1, and a first rank indicator (RI), or RI_1. The second IMR (IMR2) may be used for CSI in the absence of CLI. From IMR2, the UE may generate a feedback with a second PMI, or PMI_2, and a second RI, or RI_2. A linear combination codebook or Type I codebook may be used for CSI reporting including RI or PMI. The network may deduce the dominant interference from PMI_1 and PMI_2 and make necessary adjustment for the precoder of PMI_2. For example, the network may align a precoder for a certain layer with the dominant CLI and derive a PMI′_2. Subsequently, the network may utilize PMI′_2 for its transmission for various slots, irrespective whether it is CLI-free or CLI-present nominally.

Under the proposed scheme, two codewords may be used. In a first alternative, a UE may be configured with two CSI processes, namely process 1 and process 2. Each of the two CSI processes may be respectively configured with one NZP CSI-RS and IMR, e.g., {NZP CSI-RS, IMR1} for process 1 and {NZP CSI-RS, IMR2} for process 2. As an example, IMR1 may be used for heavy interference cases, and IMR2 may be used for light interference cases. From process 1, the UE may require a split of spatial layers according to Set 1={1:N1}, for codeword 1, and set 2={N1+1:N1+N2}, for codeword 2 (with MATLAB like notations used). For process 2, the UE may be constrained to report a split of spatial layers according to codeword 1, with {set 1} U {possible additional spatial layer(s) not from set 2}, and codeword 2, with {set 2} U {possible additional spatial layer(s) not from set 1}. In a second alternative, a single CSI process may be configured with two subsets of slots, and the reported CSI may be referred to the subsets of slots by using IMR(s) residing on each subset of slots, thereby effectively achieving the same as the first alternative.

### Multiple-Bit HARQ Feedback

In NR, a codeword consists of one or more codeblocks, and each codeblock belongs to one codeblocks, hence all the codeblocks under a codeword can be divided into one or more codeblock groups. Under a proposed scheme in accordance with the present disclosure, HARQ feedback with multiple bits may be used to indicate to a base station that one or more codeblock(s)/codeblock group(s) have been received correctly. Consequently, retransmission may be conducted for other codeblocks/codeblock groups which are not received correctly.

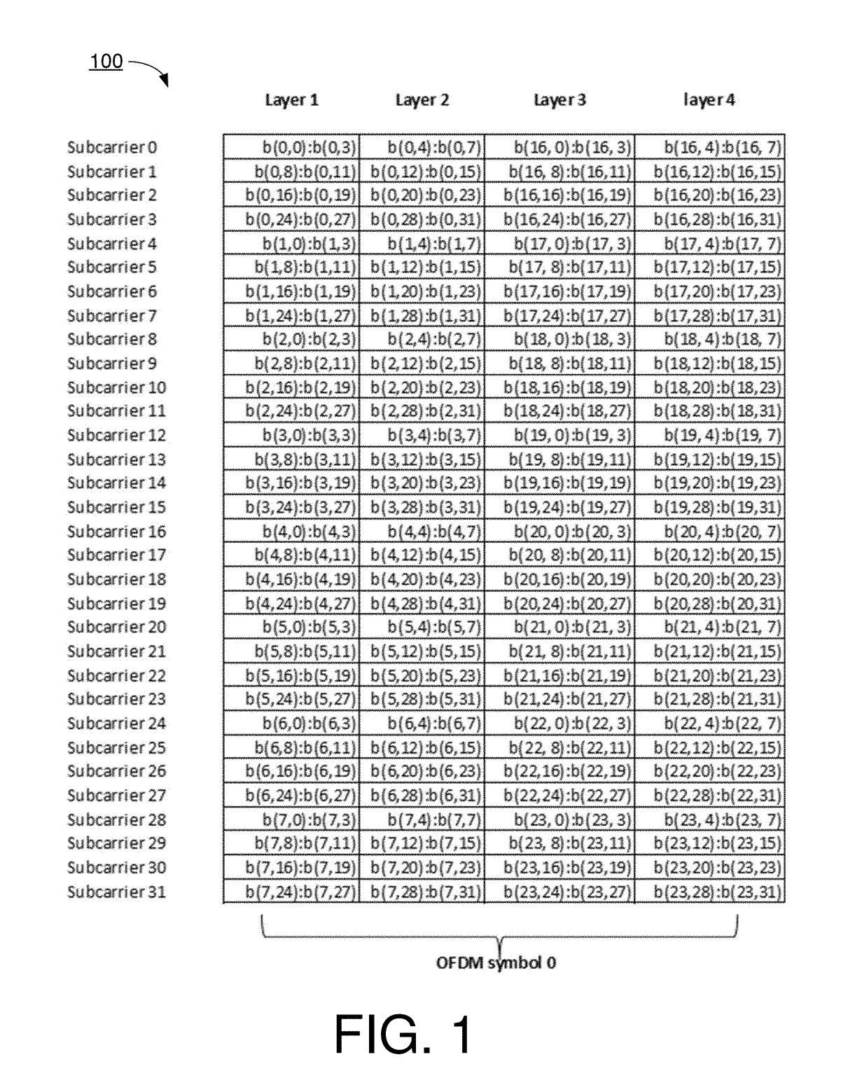

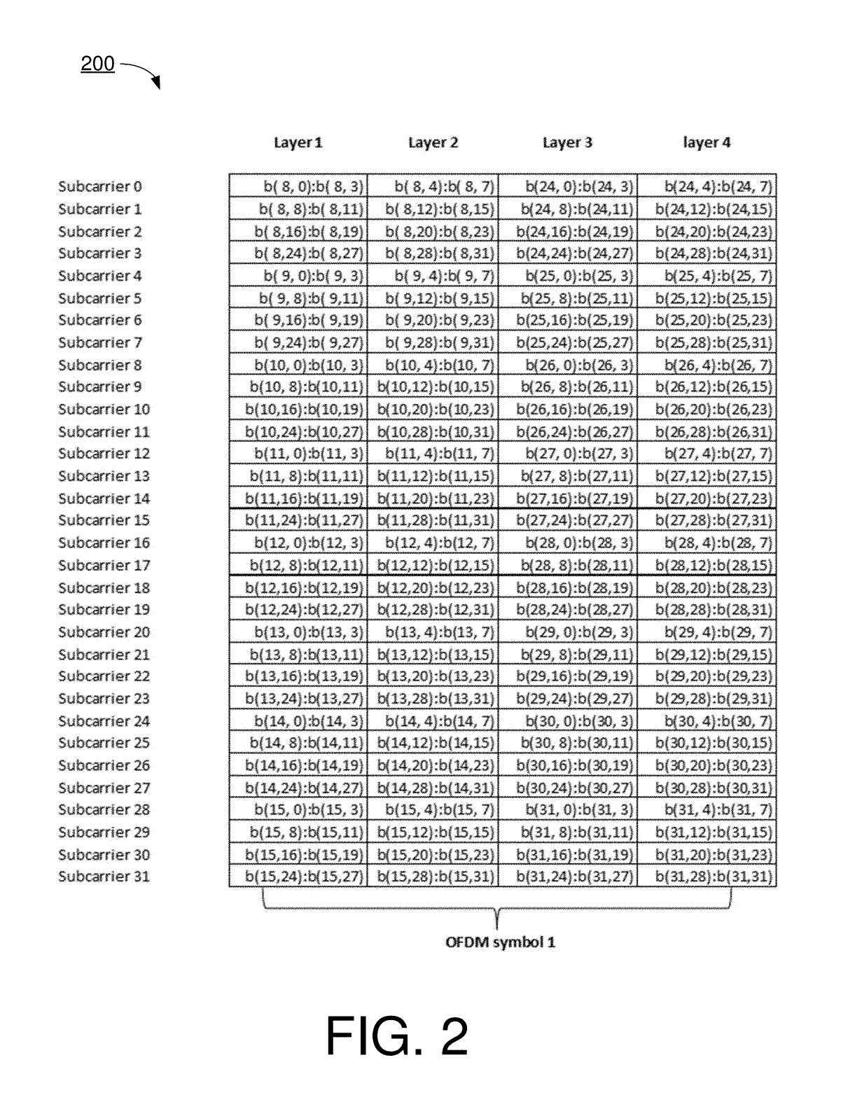

FIG. 1 illustrates an example codeblock mapping 100 over an orthogonal frequency-division multiplexing (OFDM) symbol 0 in accordance with an implementation of the present disclosure, where b(x,y) stands for the y-th bit in the x-th codeblock. FIG. 2 illustrates an example codeblock mapping 200 over an OFDM symbol 1 in accordance with an implementation of the present disclosure. In FIG. 1 and FIG. 2, an example of transmission over two OFDM symbols (e.g., symbol 0 and symbol 1) at four spatial layers and 32 tones is provided to illustrate codeblock mapping over spatial layer, frequency and time, which may be used with above-described MIMO transmission strategy. With the above-described transmission strategy, codeblock (or codeblock group) mapping may lead to half of the codeblocks (or codeblock groups) being received correctly (e.g., over spatial layers 1 and 2), and the other half received in error. In contrast, when codeblock mapping is through all spatial layers, it may happen that all codeblocks are received in error.

Furthermore, under the proposed scheme, HARQ feedback states may include error cases often encountered in dynamic TDD. As an example, the latter half of codeblocks in a codeword may be impacted by CLI, and in such case a code state indicating such condition may be included in a multiple-bit feedback. It may be assumed that all codeblocks on a spatial layer or specific spatial layers may be in error.

In the example shown in FIG. 1 and FIG. 2, four spatial layers are used for transmission. The four spatial layers are divided into two groups, namely, {layer 1, layer 2} in Group 1 with P₁, and {layer 3, layer 4} in Group 2 with P₂. In the example, one channel quality indicator (CQI) may be fed back from the UE for all spatial layers. The base station may assume that each spatial layer supports the same spectral efficiency. One transport block may be encoded into one codeword, e.g., with cyclic-redundancy check (CRC) attachment for the codeword, and CRC attachment for codeblocks or codeblock groups, channel encoding, rate matching and so forth. In the example, one codeword consists of 32 codeblocks. Codeblocks 0˜15 are mapped to Group 1 and codeblocks 16˜31 are mapped to Group 2.

For HARQ feedback, codeblocks may be aggregated into codeblock groups. For example, codeblocks 0˜3 may belong to Codeblock Group 1, codeblocks 4˜7 may belong to Codeblock Group 2, codeblocks 8˜11 may belong to Codeblock Group 3, codeblocks 12˜15 may belong to Codeblock Group 4, codeblocks 16˜19 may belong to Codeblock Group 5, codeblocks 20˜23 may belong to Codeblock Group 6, codeblocks 24˜27 may belong to Codeblock Group 7, and codeblocks 28˜31 may belong to Codeblock Group 8. With severe CLI, it may happen that all the codeblocks on some spatial layers are received in error. For example, codeblocks 16˜31 may be received in error. In addition, it may also happen that a few codeblocks from codeblocks 0˜15 may be received in error. Under the proposed scheme, some code states in the multiple-bit HARQ feedback may be defined to indicate block error(s) on one or more spatial layers as well as random error in other codeblock group(s). Accordingly, unnecessary retransmission may be avoided.

In view of the above, it is believed that one of ordinary skill in the art would appreciate that, under a proposed scheme, each codeblock may be mapped to a spatial layer group when possible, which may not include all utilized spatial layers in a PDSCH transmission. Moreover, under the proposed scheme, each codeblock group may stay on the same spatial layer group when possible.

### Resource Element Mapping Order and Interleaver

In general, there is a tradeoff between obtaining diversity gain and processing latency. Considering a simple block interleaver of size m·n, consisting of m rows and n columns, that reads input sequence x={xᵢ, 1≤i≤m·n} row by row to output a sequence y={yⱼ,1≤j≤m·n} column by column. The relationship between input and output may be expressed as yⱼ=x_{π}_{_{m,n}}₍ⱼ₎, where π_{m,n}(i) is a permutation function and its inverse function as represented by Expression (15) and Expression (16) below, respectively.

$$\begin{matrix}{π}_{m , n} ( j ) = ( ( j - 1 ) \% m ) \cdot n + ⌊ \frac{j - 1}{m} ⌋ + 1 & ( 15 ) \\ {π}_{m , n}^{- 1} ( i ) = ( ( i - 1 ) \% n ) \cdot m + ⌊ \frac{i - 1}{n} ⌋ + 1 & ( 16 )\end{matrix}$$

Adjacent elements in the input sequence may be separated by m elements after interleaving. By choosing interleaver size (e.g., m·n), the region that a codeblock is spread out may be controlled to control the diversity level and latency (if it is across OFDM symbols). Moreover, by choosing m, how a codeblock is distributed in an m·n block may be controlled. Under a proposed scheme in accordance with the present disclosure, a procedure may involve the following: (1) for segmentation, input codeblocks may be partitioned into K segments with each having a size of m·n; and (2) for interleaving, an interleaving operation π_{m,n} may be applied on each segment. Accordingly, the interleaver design may be harmonized.

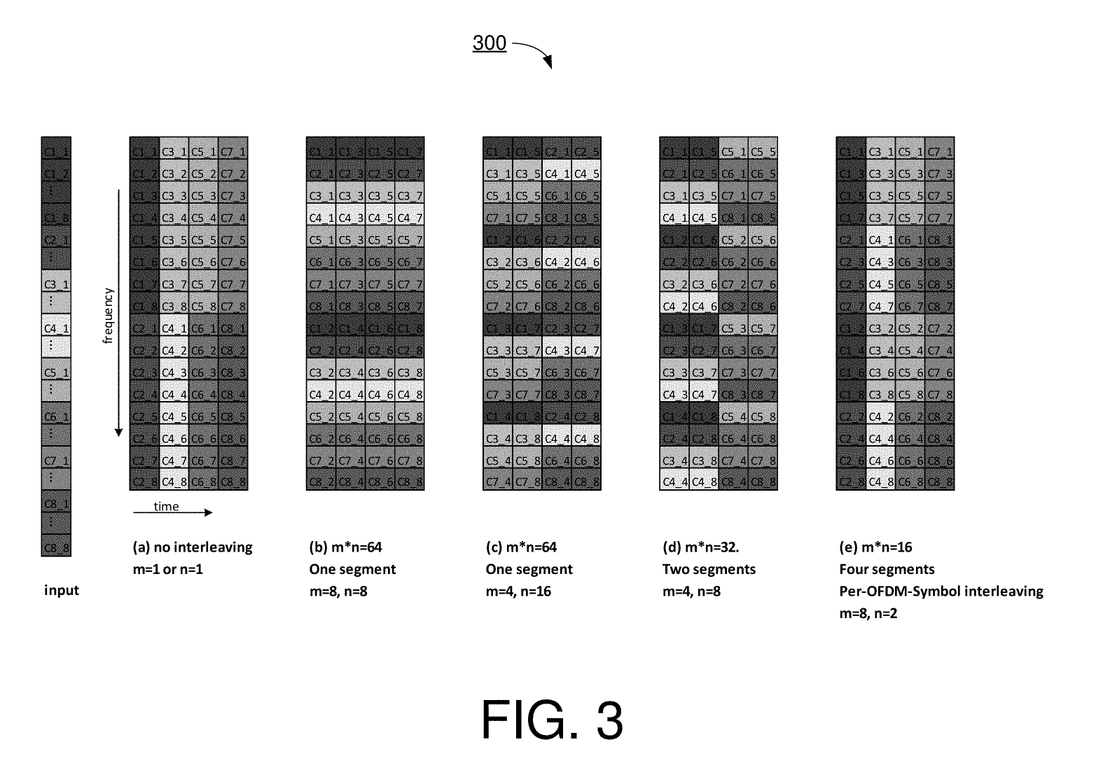

FIG. 3 illustrates an example scenario 300 of frequency-time interleaving with different parameters in accordance with an implementation of the present disclosure. Scenario 300 is an example in which a transmission time interval (TTI) over four OFDM symbols with eight codeblocks (with different shading as shown in FIG. 3), each having eight modulation symbols. Assuming the mapping order is frequency→time, part (A) of FIG. 3 shows the codeblocks without interleaving in a two-dimensional (2D) grid. Part (B) of FIG. 3 shows the configuration (m=8,n=8) that a codeblock is spread over two parts in frequency over four OFDM symbols. By setting to m=4, n=16, as in part (C) of FIG. 3, the decoding processing start time may be restricted to be two OFDM symbols while each codeblock is spread over four parts in frequency. Part (D) of FIG. 3 shows similar distribution as part (C) of FIG. 3 but with codeblocks split into two segments (C1˜C4 and C5˜C8) first with two separate interleaving processes (with half of size) for each segment. Segmentation in part (D) of FIG. 3 may be useful when C1˜C4 belong to a codeblock group sharing HARQ process and each codeblock group is to be sequentially processed. By splitting input codeblocks into multiple segments (aligned with codeblock groups), the latency for each HARQ processing is controllable. Part (E) of FIG. 3 shows the setting that corresponds to per-OFDM-symbol interleaving.

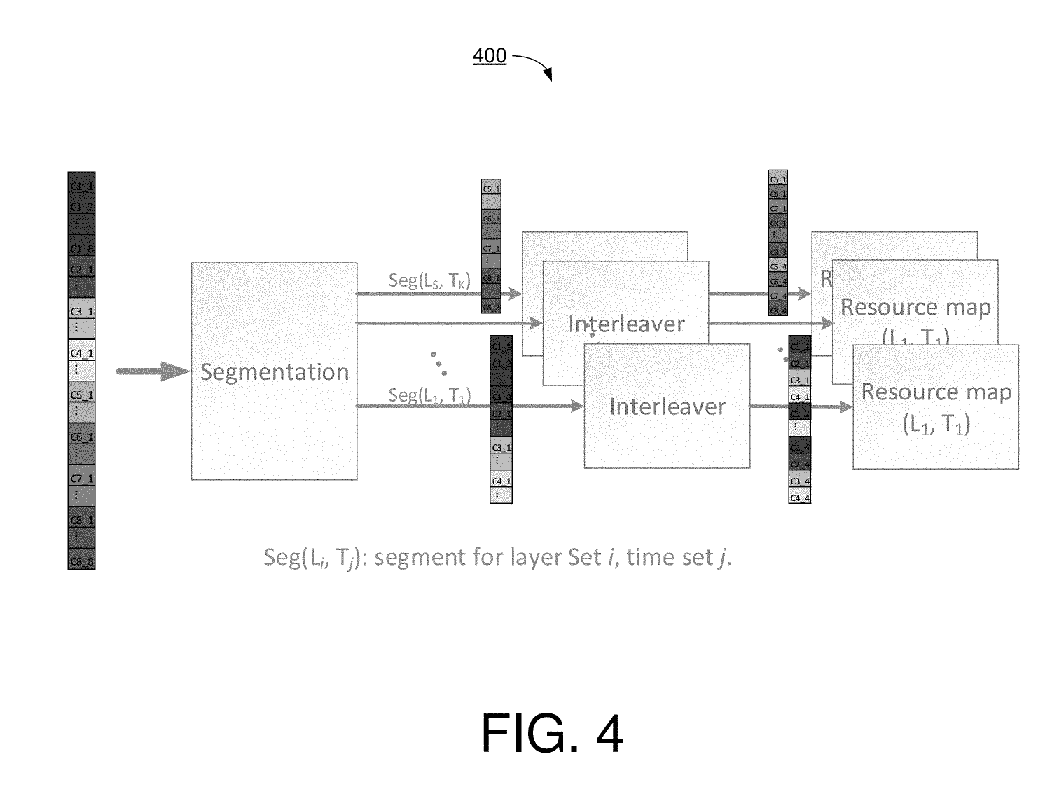

This layer grouping may help to localize burst error to a certain codeblock group to achieve better overall performance. The layer domain grouping can be easily incorporated in the segmentation step of the aforementioned procedure. FIG. 4 illustrates an example scenario 400 of codeblock partitioning in accordance with an implementation of the present disclosure. In scenario 400, codeblocks are partitioned into s·K segments with s layer sets and K time (OFDM symbol) sets. After segmentation, symbols in each segment may pass through an interleaver and then may be mapped to corresponding resource elements. In view of the above, it is believed that one of ordinary skill in the art would appreciate that, under a proposed scheme, support for configurable segmentation and interleaving of codeblock groups in NR is provided.

### Intra-Codeblock Interleaver Design

According to PDSCH resource allocation and rate matching situation (e.g., presence of phase tracking reference signal (PT-RS) and CSI-RS), the number of data REs per spatial layer (S) for the PDSCH may be first determined. With the number of spatial layers being N_{L}, the modulation order being Qₘ (e.g., 2 for QPSK, 8 for QAM256), and the number of codeblocks being C, let γ=S mod C and let Eₖ be the number of coded bits for codeblock k, if 0≤k≤C−γ−1, then Eₖ=N_{L}·Qₘ└S/C┘; and if k≥C−γ, then Eₖ=N_{L}·Qₘ┌S/C┐.

For a given modulation order, the least-significant bit (LSB) and the most-significant bit (MSB) bits in a modulation symbol have different reliability levels. In this case, the bits for a modulation symbol may be divided into two groups: a bits for group 1 and b bits for group 2. Bits in group 1 may not be less reliable than bits in group 2, and a+b=Qₘ. For a given modulation order (e.g., Qₘ=8), there may be a number of partitions of the Qₘ bits, (a,b)=(0,8), (1,8), . . . , (8,0). With a given partition (a,b), a codeblock at coding rate a/(a+b) can be supported by taking a bits from group 1 and b bits from group 2 alternatively. For example, if the coding rate for the codeblock happens to be ½, then (a,b)=(4,4) can be used. In case the coding rate cannot be supported with a single partition, then two partitions (a₁, b₁) and (a₂, b₂) leading to the closest approximation to the coding rate can be used: a₁/(a₁+b₁)<coding rate<a₂/(a₂+b₂).

For the codeblock, with the number of systematic bits (or high-priority bits, which may include bits at the B block in pulse code modulation (PCM)) being Nₛ, the number of using partition (a₁, b₁) being x₁, the number of using partition (a₂, b₂) being x₂ in the mapping or readout procedure, then x₁ and x₂ may be solved by Expression (17) below.

$$\{ \begin{matrix}{x}_{1} {a}_{1} + {x}_{2} {a}_{2} & = {N}_{s} \\ {x}_{1} + {x}_{2} & = {E}_{k}\end{matrix} \qquad ( 17 )$$

With x₁ and x₂ known, a readout schedule may be considered. There may be a number of options. Assume x₁≥x₂, using 1 for using partition 1 and 2 for using partition 2, the readout procedure as represented by Expression (18) or Expression (19) below may be started.

$$\begin{matrix}{1 ⋯1}_{\begin{matrix}⏟ \\ {X}_{1} times ,\end{matrix}} {2 ⋯2}_{\begin{matrix}⏟ \\ {x}_{2} times\end{matrix}} , & ( 18 ) \\ {12 ⋯12}_{\begin{matrix}⏟ \\ {x}_{2} times ,\end{matrix}} {1 ⋯1}_{\begin{matrix}⏟ \\ {x}_{1} - {x}_{2} times\end{matrix}} & ( 19 )\end{matrix}$$

It is open for redundancy version without systematic bits, as a rule may still be needed to assign importance to the selected parity bits, for example, by examining their weights. There may also be options in the ordering of the high-priority bits and the low-priority bits. For base graph 1 (BG1), the base matrix is 46×68. The systematic bits for the initial transmission are located in a Z×22 sub-matrix (starting from column 3 counting from 1). The systematic bits may be read out column by column or row by row in the sub-matrix. The same options may exist for the parity bits.

As multiple-bit HARQ feedback is supported in NR, with N_{g} being the number of codeblock groups given for a PDSCH, it may be beneficial to have an equal number or approximately equal number of codeblocks under codeblock groups. It may also be assumed that with a given base graph (BG1 or BG2), the lifting factor Z may be chosen so that the resulted number of codeblocks under one transport block may be a multiple of N_{g}.

With the readout schedule described above, systematic bits and parity bits may be loaded from the MSB to the LSB in a modulation symbol, which may provide performance benefits when the codeblock is received under normal conditions without puncturing due to ultra-reliable low latency communication (URLLC). In case that URLLC puncturing occurs over the PDSCH, if no interleaver is used, then the puncturing pattern is quite regular and can be quite damaging. Accordingly, under a proposed scheme in accordance with the present disclosure, an intra-codeblock interleaver may be provided. A pseudo-random interleaver may be applied to the collection of systematic and parity bits with or without the bit-loading readout procedure. One design option may be block interleaver. Another design option may be a turbo-block interleaver. Assuming the bit-loading readout procedure is not used and the intra-codeblock interleaver directly works on the systematic and parity bits, the proposed scheme provides a way to read out the coded bits.

Using BG1 as an example, as the parity checking matrix is a 46×68 matrix, and with the first two columns punctured all the time, it can be seen that if puncturing happens the puncturing happens towards the end of the codeword. When URLLC punctures an enhanced Mobile Broadband (eMBB) transmission, with the signaling provided in the common Physical Downlink Control Channel (PDCCH), a UE can determine what parts of the eMBB transmission are impacted by URLLC transmission and thus take corresponding action (e.g., zero out all impacted LLRs). From that, it is understood that coded bits are of different importance in a codeword, and the effect of puncturing can be different depending on the exact location where puncturing takes place.

Assuming Z=4, . . . ,384, then the coded bits before bit selection for rate-matching fil a Z×66 matrix as represented by Expression (20) below.

$$C = [ \begin{matrix}{b}_{1} & {b}_{z + 1} & ⋯ & {b}_{65 z + 1} \\ {b}_{2} & {b}_{z + 2} & ⋯ & {b}_{65 z + 2} \\ ⋮ & ⋮ & ⋮ & ⋮ \\ {b}_{z} & {b}_{2 \cdot z} & ⋯ & {b}_{66 z}\end{matrix} ] \qquad ( 20 )$$

Depending on the modulation coding scheme (MCS) level, twenty-two columns of the matrix (including a possible fractional column) are selected for transmission.

To illustrate the considered scheme, assume that the codeblock is mapped to two spatial layers with QAM16 and Z=8, sixty columns of the coded bit matrix are selected for transmission Then, b₁ to b₈ are mapped to RE 1 (with b₁ to b₄ mapped to one QAM16 symbol on spatial layer 1, and b₅ to b₈ mapped to one QAM16 symbol on spatial layer 2), and b₉ to b₁₆ are mapped to RE 2, and so on. If a URLLC transmission punctures PRB 1 (e.g., RE 1 to RE 12), then all the high-importance bits are impacted. Accordingly, it can be beneficial to consider an interleaver or alternate readout order. Instead of reading out the coded bits column by column, the coded bits may be read out row by row (skipping un-transmitted bits on each row). With the example under consideration, the following may be obtained:

b₁, b₉, b₁₇, b₂₅, b₃₃, b₄₁, b₄₉, b₅₇, b₆₅, b₇₃, b₈₁, b₈₉, b₉₇, b₁₀₅, b₁₁₃, b₁₂₁, b₁₂₉, b₁₃₇, b₁₄₅, b₁₅₃, b₁₆₁,

b₁₆₉, b₁₇₇, b₁₈₅, b₁₉₃, b₂₀₁, b₂₀₉, b₂₁₇, b₂₂₅, b₂₃₃, b₂₄₁, b₂₄₉, b₂₅₇, b₂₆₅, b₂₇₃, b₂₈₁, b₂₈₉, b₂₉₇, b₃₀₅, b₃₁₃, b₃₂₁, b₃₂₉, b₃₃₇, b₃₄₅, b₃₅₃, b₃₆₁, b₃₆₉, b₃₇₇, b₃₈₅, b₃₉₃, b₄₀₁, b₄₀₉, b₄₁₇, b₄₂₅, b₄₃₃, b₄₄₁, b₄₄₉,

b₄₅₇,b₄₆₅, b₄₇₃, b₂, b₁₀, b₁₈, b₂₆, b₃₄, b₄₂, b₅₀ b₅₈, b₆₆, b₇₄, b₈₂, b₉, b₉₈, b₁₀₆,b₁₁₄, b₁₂₂, b₁₃₀,

b₁₃₈, b₁₄₆, b₁₅₄, b₁₆₂, b₁₇₀, b₁₇₈, b₁₈₆, b₁₉₄, b₂₀₂, b₂₁₀, b₂₁₈, b₂₂₆, b₂₃₄, b₂₄₂, b₂₅₀, b₂₅₈, b₂₆₆, b₂₇₄,

b₂₈₂, b₂₉₀, b₂₉₈, b₃₀₆, b₃₁₄, b₃₂₂, b₃₃₀, b₃₃₈, b₃₄₆, b₃₅₄, b₃₆₂, b₃₇₀, b₃₇₈, b₃₈₆, b₃₉₄, b₄₀₂, b₄₁₀, b₄₁₈,

b₄₂₆, b₄₃₄, b₄₄₂, b₄₅₀, b₄₅₈, b₄₆₆, b₄₇₄ . . . ,

b₈, b₁₆, b₂₄, b₃₂, b₄₀, b₄₈, b₅₆, b₆₄, b₇₂, b₈₀, b₉₆, b₁₀₄, b₁₁₂, b₁₂₀, b₁₂₈, b₁₃₆, b₁₄₄, b₁₅₂,

b₁₆₀, b₁₆₈, b₁₇₆, b₁₈₄, b₁₉₂, b₂₀₀, b₂₀₈, b₂₁₆, b₂₂₄, b₂₃₂, b₂₄₀, b₂₄₈, b₂₅₆, b₂₆₄, b₂₇₂, b₂₈₀, b₂₈₈, b₂₉₆,

b₃₀₄, b₃₁₂, b₃₂₀, b₃₂₈, b₃₃₆, b₃₄₄, b₃₅₂, b₃₆₀, b₃₆₈, b₃₇₆, b₃₈₄, b₃₉₂, b₄₀₀, b₄₀₈, b₄₁₆, b₄₂₄, b₄₃₂, b₄₄₀,

b₄₄₈, b₄₅₆, b₄₆₄, b₄₇₂, b₄₈₀.

There may be additional benefits to shuttle columns before the row-by-row readout. For instance, assuming the number of selected columns for transmission is S, then d_{i,j}=c_{i′,j}, where i′=mod(i+K·j,Z),

$$K = ⌈ \frac{Z}{L} ⌉ , L = ⌈ \frac{M}{Z} ⌉ ,$$

where M is the number of bits to be transmitted for the codeblock, 0≤i≤Z−1, 0≤j≤65. Here, K can also be restricted to be a multiple of 8, so byte-aligned operation can be facilitated. Here, c_{i,j} is the element at row i (counting from 0) and column j (counting from zero) in matrix C as given above (e.g., C_{0,0}=b₁). Moreover, d_{i,j} is the element at row i (counting from 0) and column j (counting from zero) in matrix D, which is a Z×66 matrix. It may happen that not all the bits on column L−1 are selected for transmission. For example, M=24000, Z=384, L=63, then c_{62,n} or d_{62,n}, n=192,192, . . . ,383 are not transmitted. The “Y” is written over those un-transmitted bits on column L−1 of C or D. Then, readout is given by rₙ=d_{i′,j′}, i′=└n/Z┘, j′=n−i′·L. Next, rₙ may be removed if rₙ=Y.

### Channel Interleaver Design (VRB-PRB Mapping)

In NR, physical resource block (PRB) bundling can be enabled, and the bundle size can be 1, 2, 4, 8 or 16. It can be assumed that, when a PDSCH spans over multiple bundles, the channel estimator at the receiver may be performed in an arbitrary order with respect to the bundles (e.g., in a natural order with bundle 1, bundle 2, bundle 3, and so on with a single channel estimation engine) or with a schedule (e.g., bundle 1, bundle 3, bundle 5, bundle 2, and so on).

With respect to the interaction between bundle size and processing latency, for a PDSCH with 40 codeblocks, QAM256, 11/20 coding rate and four spatial layers, there are 15,360 coded bits for a codeblock with 384×22 information bits. Assuming there are 120 REs available in one PRB (12 tones over 10 OFDM symbols, ignoring the demodulation reference signal (DMRS) overhead), then 160 PRBs are needed to transmit all 40 codeblocks. By using the space→frequency→time mapping order, four codeblocks can be mapped on each OFDM symbol assuming the bundle size is eight.

In a first case with no channel interleaver used, after performing channel estimation on PRBs in the first six bundles (e.g., PRBs 1˜48), all the log-likelihood ratios (LLRs) for the codeblock become available when PRB 44 is processed. In a second case, in case coded bits are equally spread over two bundles, the LLRs become available after channel estimation for the first bundle and processing over a third PRB in the second bundle. In case a single channel estimation engine is used, the processing latency is more compared with the first case. Spreading one codeblock over two or more bundles may lead to a robust transmission as frequency diversity is achieved. There is no apparent choice for the number of bundles over which a codeblock is spread. In case a single channel estimation engine is used then the processing latency is roughly proportional to the number of bundles over which a codeblock is spread (or the degree of frequency diversity).

In the following procedure, with the number of PRBs in a PDSCH allocation being A, the PRB bundle size being B, the desired degree of frequency diversity being D, the PRB mapping order (rectangular interleaver with a PRB bundle as the basic unit) may be determined by the following: (1) x₁=┌A/B┐ (roughly the number of bundles in the PDSCH); and (2) x₂=└x₁/D┘ (roughly the number of bundles for each frequency segment). For PRB mapping, virtual PRB k, 0≤k≤A−1, may be mapped to physical PRB f(k) as represented by Expression (21) below, where b=└k/B┘.

f(k)=(mod(b,D)·x₂+└b/D┘)·B+mod(k,B), (21)

For example, for A=32, B=4, D=4, f(k)=0, 1, 2, 3, 8, 9, 10, 11, 16, 17, 18, 19, 24, 25, 26, 27, 4, 5, 6, 7, 12, 13, 14, 15, 20, 21, 22, 23, 28, 29, 30, 31.

For example, for A=32, B=4, D=2, f(k)=0, 1, 2, 3, 16, 17, 18, 19, 4, 5, 6, 7, 20, 21, 22, 23, 8, 9, 10, 11, 24, 25, 26, 27, 12, 13, 14, 15, 28, 29, 30, 31.

### Illustrative Implementations

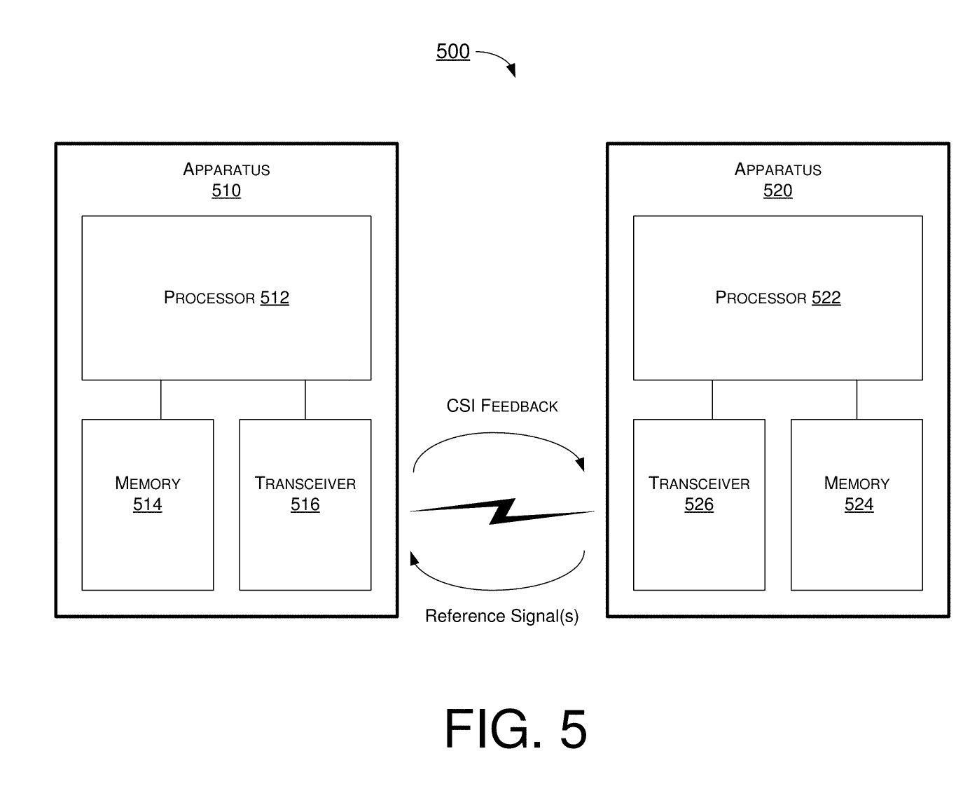

FIG. 5 illustrates an example system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to codeword mapping in NR and interleaver design for NR, including the various schemes described above with respect to various proposed designs, concepts, schemes, systems and methods described above as well as processes 600 and 700 described below.

Each of apparatus 510 and apparatus 520 may be a part of an electronic apparatus, which may be a network apparatus or a UE, such as a portable or mobile apparatus, a wearable apparatus, a wireless communication apparatus or a computing apparatus. For instance, each of apparatus 510 and apparatus 520 may be implemented in a smartphone, a smartwatch, a personal digital assistant, a digital camera, or a computing equipment such as a tablet computer, a laptop computer or a notebook computer. Each of apparatus 510 and apparatus 520 may also be a part of a machine type apparatus, which may be an Internet-of-Things (IoT) apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in an eNodeB in an LTE, LTE-Advanced or LTE-Advanced Pro network or in a gNB or TRP in a 5G network, an NR network or an IoT network.

In some implementations, each of apparatus 510 and apparatus 520 may be implemented in the form of one or more integrated-circuit (IC) chips such as, for example and without limitation, one or more single-core processors, one or more multi-core processors, or one or more complex-instruction-set-computing (CISC) processors. In the various schemes described above, each of apparatus 510 and apparatus 520 may be implemented in or as a network apparatus or a UE. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to codeword mapping in NR and interleaver design for NR in accordance with various implementations of the present disclosure.

In some implementations, apparatus 510 may also include a transceiver 516 coupled to processor 512. Transceiver 516 may be capable of wirelessly transmitting and receiving data. In some implementations, apparatus 520 may also include a transceiver 526 coupled to processor 522. Transceiver 526 may include a transceiver capable of wirelessly transmitting and receiving data.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

For illustrative purposes and without limitation, a description of capabilities of apparatus 510 and apparatus 520 is provided below in the context of apparatus 510 functioning as a UE and apparatus 520 functioning as a base station of a wireless network (e.g., a 5G NR network).

In one aspect, with respect to codeword mapping in NR, processor 512 of apparatus 510 (as a UE) may receive, via transceiver 516 and from apparatus 520 (as a network node or base station of a wireless network), a Physical Downlink Shared Channel (PDSCH) transmission. Processor 512 may map one or more codeblocks of a codeword in the PDSCH transmission to a spatial layer group which is a subset of a plurality of spatial layers. Processor 512 may transmit, via transceiver 516, to apparatus 520 a feedback concerning the one or more codeblocks.

In some implementations, the feedback may include a hybrid automatic repeat request (HARQ) feedback with multiple bits indicating a plurality of states including at least an error state. In some implementations, the error states may indicate to apparatus 520 that all codeblocks or all codeblock groups on one or more specific spatial layers of the plurality of spatial layers have been received in error.

In some implementations, in receiving the PDSCH transmission from apparatus 520, processor 512 may receive the PDSCH transmission from apparatus 520 at the plurality of spatial layers.

In some implementations, in mapping the codeblock to some but not all spatial layers of the plurality of spatial layers, processor 512 may align the spatial layer group to one or more interfering signals with one or more other spatial layer groups of the plurality of spatial layers orthogonal to the one or more interfering signals. In some implementations, the codeblock may include one or more codeblock groups. Additionally, each codeblock group of the one or more codeblock groups may stay on the spatial layer group at least during the transmitting of the codeblock to apparatus 520.

In some implementations, processor 512 may utilize a first interference measurement resource (IMR) in receiving a non-zero power (NZP) channel state information reference signal (CSI-RS) from the network node in a presence of a cross-link interference (CLI). Additionally, process 512 may utilize a second IMR in receiving the NZP CSI-RS from the network node in an absence of the CLI. Moreover, processor 512 may generate a first precoding matrix indicator (PMI) and a first rank indicator (RI) in an event that the first IMR is utilized. Furthermore, process 512 may generate a second PMI and a second RI in an event that the second IMR is utilized. Additionally, processor 512 may transmit, via transceiver 516 and to apparatus 520, a feedback including either the first PMI and the first RI or the second PMI and the second RI, or both.

In some implementations, in generating the first PMI, the second PMI, the first RI and the second RI, processor 512 may generate the first PMI, the second PMI, the first RI and the second RI based on based on Type I single-panel codebook, Type I multi-panel codebook, Type II codebook, or Type II port-selection codebook defined in NR.

In some implementations, processor 512 may utilize a first process associated with a first IMR in receiving an NZP CSI-RS from the network node in a presence of a heavy CLI. Additionally, processor 512 may utilize a second process associated with a second IMR in receiving the NZP CSI-RS from the network node in a presence of a light CLI. Moreover, processor 512 may generate, using the first process, a first codeword mapped to a first group of spatial layers as well as a second codeword mapped to a second group of spatial layers not overlapping with the first group (e.g., in an event that the first IMR is utilized). Furthermore, processor 512 may generate, using the second process, the first codeword mapped to the first group of spatial layers and any spatial layer not in the second group as well as the second codeword mapped to the second group of spatial layers and any spatial layer not in the first group (e.g., in an event that the second IMR is utilized). Additionally, processor 512 may transmit, via transceiver 516, to apparatus 520 a feedback associated with the first codeword and the second codeword.

In some implementations, processor 512 may utilize a process with a first subset of slots in receiving an NZP CSI-RS from the network node in a presence of a heavy CLI. Additionally, process 512 may utilize the process with a second subset of slots in receiving the NZP CSI-RS from the network node in a presence of a light CLI. Moreover, processor 512 may generate, using the process, a first codeword and a second codeword using a first IMR residing on the first subset of slots in case that the heavy CLI is present. It is noteworthy that the UE (e.g., apparatus 510) can measure IMR and follow command(s) from the network (e.g., apparatus 520) to generate codeword on spatial layers, but the UE cannot determine which layers are used to transmit codeword by only knowing IMR information. Furthermore, processor 512 may generate, using the process, the first codeword and the second codeword using a second IMR residing on the second subset of slots in case that the light CLI is present. Additionally, processor 512 may transmit, via transceiver 516, to apparatus 520 a feedback comprising the first codeword and the second codeword.

In some implementations, processor 512 may select, according to a control signaling from apparatus 520 as a network node, a first subset of one or more spatial layers mapped to a first codeword and a second subset of one or more spatial layers from the plurality of spatial layers mapped to a second codeword.

In some implementations, in selecting the first subset of one or more spatial layers, processor 512 may separate the plurality of spatial layers into the first subset of one or more spatial layers and the second subset of one or more spatial layers. Additionally, the first subset and the second subset may be contiguous in a spatial domain. Moreover, either the first subset or the second subset may include one or more interference layers.

In some implementations, processor 512 may perform a number of operations. For instance, processor 512 may pair every two spatial layers of the plurality of spatial layers to form a set of pairs of spatial layers. Moreover, processor 512 may select, according to a control signaling from apparatus 520 as a network node, a first subset of one or more pairs from the set of pairs for a first codeword and a second subset of one or more pairs from the set of pairs for a second codeword. Furthermore, the control signaling may indicate that the first subset of one or more pairs of spatial layers is mapped to the first codeword and that a second subset of one or more pairs of spatial layers from the set of pairs is mapped to a second codeword.

In some implementations, processor 512 may perform a number of operations. For instance, processor 512 may partition each codeblock of the one or more codeblocks into a plurality of segments each having a size of m·n with m rows and n columns. Moreover, processor 512 may apply an interleaving operation on each segment of the plurality of segments. Furthermore, prior to the partitioning, processor 512 may determine a size of an interleaver that performs the interleaving operation to control a region in which each a respective codeblock of the one or more codeblocks is spread out to thereby control a diversity level and latency. In such cases, the respective codeblock may be transmitted across multiple OFDM symbols. Alternatively, or additionally, prior to the partitioning, processor 512 may determine a value of each of m and n to control how a respective codeblock of the one or more codeblocks is distributed in a m·n block.

In some implementations, the PDSCH may span over a plurality of physical resource block (PRB) bundles, with each PRB bundle including respective multiple PRBs. In such cases, the interleaving may be performed over the plurality of PRB bundles with each PRB bundle of the plurality of PRB bundles being an individual interleaving unit.

In one aspect, with respect to interleaver design for NR, processor 512 may receive, via transceiver 516 and from apparatus 520, a PDSCH transmission. Processor 512 may perform receiving processing for one or more codeblocks in the PDSCH transmission including by performing de-interleaving on a result from a channel interleaver and/or from an intra-codeblock interleaver that performs pseudo-random interleaving on systematic bits and parity bits of the one or more codeblocks and channel decoding. Processor 512 may transmit, via transceiver 516 and to apparatus 520, a feedback reporting a result of the receiving processing.

In some implementations, the intra-codeblock interleaver may include a block interleaver or a turbo-block interleaver.

In some implementations, the channel interleaver may include a rectangular block interleaver with a unit of resource block bundle. Moreover, write-in of the channel interleaver may follow one dimension and read-out of the channel interleaver may follow another dimension.

### Illustrative Processes

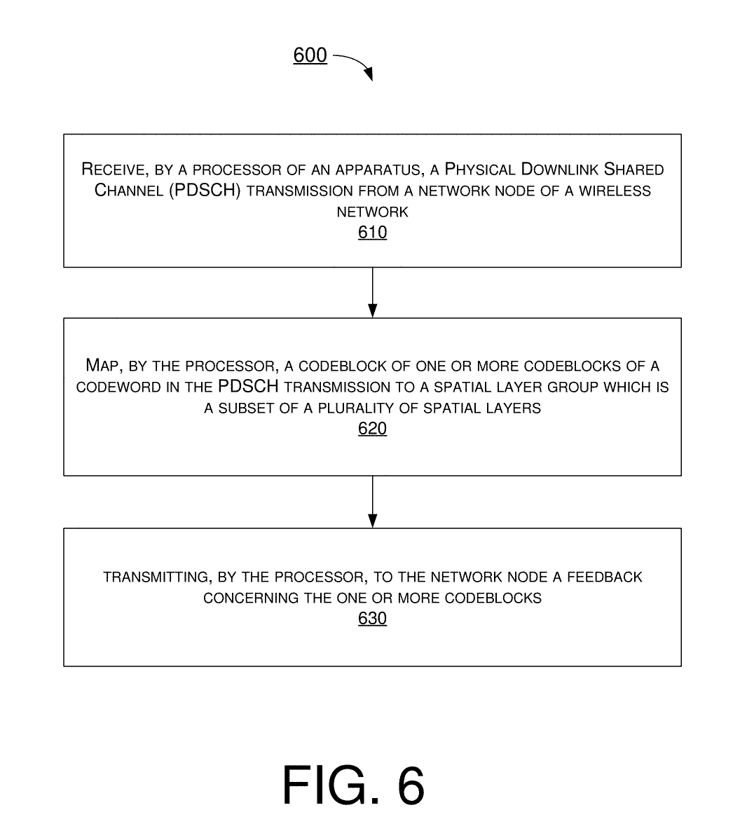

FIG. 6 illustrates an example process 600 of wireless communication in accordance with an implementation of the present disclosure. Process 600 may represent an aspect of implementing the proposed concepts and schemes such as those described above. More specifically, process 600 may represent an aspect of the proposed concepts and schemes pertaining to codeword mapping in NR and interleaver design for NR. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Process 600 may be implemented by communications system 500 and any variations thereof. For instance, process 600 may be implemented in or by apparatus 510 as a UE with apparatus 520 functioning as a network node or base station (e.g., eNB, gNB or TRP) of a wireless network (e.g., a 5G NR network). Solely for illustrative purposes and without limiting the scope, process 600 is described below in the context of first apparatus 510. Process 600 may begin at block 610.

At 610, process 600 may involve processor 512 of apparatus 510 (as a UE) receiving, via transceiver 516 and from apparatus 520 (as a network node or base station of a wireless network), a Physical Downlink Shared Channel (PDSCH) transmission. Process 600 may proceed from 610 to 620.

At 620, process 600 may involve processor 512 mapping one or more codeblocks of a codeword in the PDSCH transmission to a spatial layer group which is a subset of a plurality of spatial layers. Process 600 may proceed from 620 to 630.

At 630, process 600 may involve processor 512 transmitting, via transceiver 516, to apparatus 520 a feedback concerning the one or more codeblocks.

In some implementations, the feedback may include a hybrid automatic repeat request (HARQ) feedback with multiple bits indicating a plurality of states including at least an error state. In some implementations, the error states may indicate to apparatus 520 that all codeblocks or all codeblock groups on one or more specific spatial layers of the plurality of spatial layers have been received in error.

In some implementations, in receiving the PDSCH transmission from apparatus 520, process 600 may involve processor 512 receiving the PDSCH transmission from apparatus 520 at the plurality of spatial layers.

In some implementations, in mapping the codeblock, process 600 may involve processor 512 aligning the spatial layer group to one or more interfering signals with one or more other spatial layer groups of the plurality of spatial layers orthogonal to the one or more interfering signals. In some implementations, the codeblock may include one or more codeblock groups. Additionally, each codeblock group of the one or more codeblock groups may stay on the spatial layer group at least during the transmitting of the codeblock to apparatus 520.

In some implementations, process 600 may further involve processor 512 performing a number of operations. For instance, process 600 may involve processor 512 utilizing a first interference measurement resource (IMR) in receiving a non-zero power (NZP) channel state information reference signal (CSI-RS) from the network node in a presence of a cross-link interference (CLI). Additionally, process 600 may involve process 512 utilizing a second IMR in receiving the NZP CSI-RS from the network node in an absence of the CLI. Moreover, process 600 may involve processor 512 generating a first precoding matrix indicator (PMI) and a first rank indicator (RI) in an event that the first IMR is utilized. Furthermore, process 600 may involve process 512 generating a second PMI and a second RI in an event that the second IMR is utilized. Additionally, process 600 may involve processor 512 transmitting, via transceiver 516 and to apparatus 520, a feedback including either the first PMI and the first RI or the second PMI and the second RI, or both.

In some implementations, in generating the first PMI, the second PMI, the first RI and the second RI, process 600 may involve processor 512 generating the first PMI, the second PMI, the first RI and the second RI based on Type I single-panel codebook, Type I multi-panel codebook, Type II codebook, or Type II port-selection codebook defined in NR.

In some implementations, process 600 may further involve processor 512 performing a number of operations. For instance, process 600 may involve processor 512 utilizing a first process associated with a first IMR in receiving an NZP CSI-RS from the network node in a presence of a heavy CLI. Additionally, process 600 may involve processor 512 utilizing a second process associated with a second IMR in receiving the NZP CSI-RS from the network node in a presence of a light CLI. Moreover, process 600 may involve processor 512 generating, using the first process, a first codeword mapped to a first group of spatial layers as well as a second codeword mapped to a second group of spatial layers not overlapping with the first group (e.g., in an event that the first IMR is utilized). Furthermore, process 600 may involve processor 512 generating, using the second process, the first codeword mapped to the first group of spatial layers and any spatial layer not in the second group as well as the second codeword mapped to the second group of spatial layers and any spatial layer not in the first group (e.g., in an event that the second IMR is utilized). Additionally, process 600 may involve processor 512 transmitting, via transceiver 516, to apparatus 520 a feedback associated with the first codeword and the second codeword.

In some implementations, process 600 may further involve processor 512 performing a number of operations. For instance, process 600 may involve processor 512 utilizing a process with a first subset of slots in receiving an NZP CSI-RS from the network node in a presence of a heavy CLI. Additionally, process 600 may involve process 512 utilizing the process with a second subset of slots in receiving the NZP CSI-RS from the network node in a presence of a light CLI. Moreover, process 600 may involve processor 512 generating, using the process, a first codeword and a second codeword using a first IMR residing on the first subset of slots in case that the heavy CLI is present. Furthermore, process 600 may involve processor 512 generating, using the process, the first codeword and the second codeword using a second IMR residing on the second subset of slots in case that the light CLI is present. Additionally, process 600 may involve processor 512 transmitting, via transceiver 516, to apparatus 520 a feedback comprising the first codeword and the second codeword.

In some implementations, process 600 may further involve processor 512 performing a number of operations. For instance, process 600 may involve processor 512 selecting, according to a control signaling from apparatus 520 a network node, a first subset of one or more spatial layers from the plurality of spatial layers mapped to a first codeword and a second subset of one or more spatial layers from the plurality of spatial layers mapped to a second codeword.

In some implementations, in selecting the first subset of one or more spatial layers, process 600 may involve processor 512 separating the plurality of spatial layers into the first subset of one or more spatial layers and the second subset of one or more spatial layers. Additionally, the first subset and the second subset may be contiguous in a spatial domain. Moreover, either the first subset or the second subset may include one or more interference layers.

In some implementations, process 600 may further involve processor 512 performing a number of operations. For instance, process 600 may involve processor 512 pairing every two spatial layers of the plurality of spatial layers to form a set of pairs of spatial layers. Moreover, process 600 may involve processor 512 selecting, according to a control signaling from apparatus 520 as a network node, a first subset of one or more pairs from the set of pairs for a first codeword and a second subset of one or more pairs from the set of pairs for a second codeword. Furthermore, the control signaling may indicate that the first subset of one or more pairs of spatial layers is mapped to the first codeword and that a second subset of one or more pairs of spatial layers from the set of pairs is mapped to a second codeword.

In some implementations, process 600 may further involve processor 512 performing a number of operations. For instance, process 600 may involve processor 512 partitioning each codeblock of the one or more codeblocks into a plurality of segments each having a size of m·n with m rows and n columns. Moreover, process 600 may involve processor 512 applying an interleaving operation on each segment of the plurality of segments. Furthermore, prior to the partitioning, process 600 may involve processor 512 determining a size of an interleaver that performs the interleaving operation to control a region in which each a respective codeblock of the one or more codeblocks is spread out to thereby control a diversity level and latency. In such cases, the respective codeblock may be transmitted across multiple OFDM symbols. Alternatively, or additionally, prior to the partitioning, process 600 may involve processor 512 determining a value of each of m and n to control how a respective codeblock of the one or more codeblocks is distributed in a m·n block.

In some implementations, the PDSCH may span over a plurality of physical resource block (PRB) bundles, with each PRB bundle including respective multiple PRBs. In such cases, the interleaving may be performed over the plurality of PRB bundles with each PRB bundle of the plurality of PRB bundles being an individual interleaving unit.

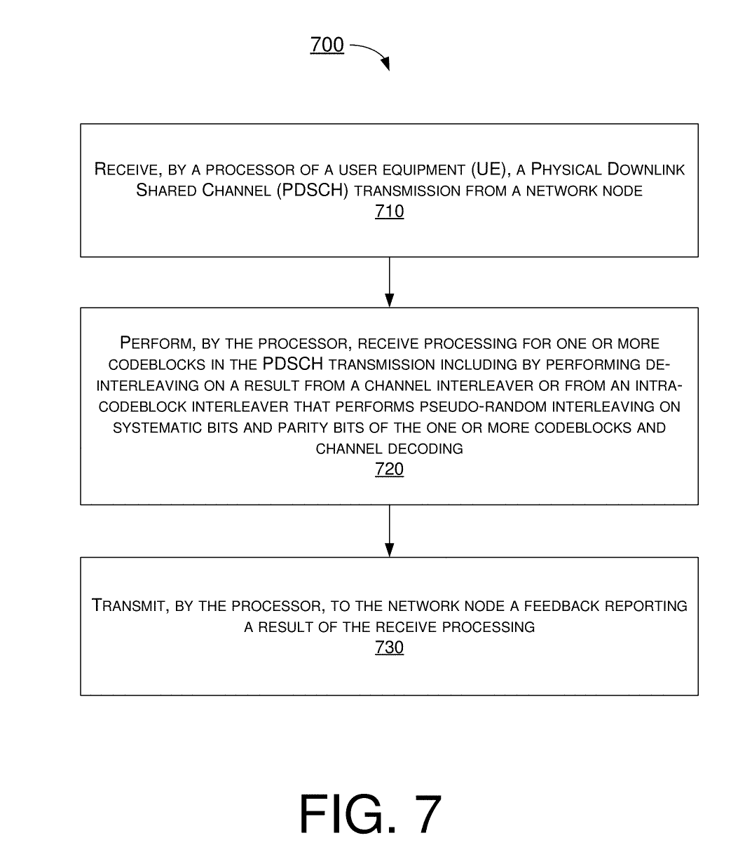

FIG. 7 illustrates an example process 700 of wireless communication in accordance with an implementation of the present disclosure. Process 700 may represent an aspect of implementing the proposed concepts and schemes such as those described above. More specifically, process 700 may represent an aspect of the proposed concepts and schemes pertaining to codeword mapping in NR and interleaver design for NR. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Process 700 may be implemented by communications system 500 and any variations thereof. For instance, process 700 may be implemented in or by apparatus 510 as a UE with apparatus 520 functioning as a network node or base station (e.g., eNB, gNB or TRP) of a wireless network (e.g., a 5G NR network). Solely for illustrative purposes and without limiting the scope, process 700 is described below in the context of first apparatus 510. Process 700 may begin at block 710.

At 710, process 700 may involve processor 512 of apparatus 510 (as a UE) receiving, via transceiver 516 and from apparatus 520 (as a network node or base station of a wireless network), a PDSCH transmission. Process 700 may proceed from 710 to 720.

At 720, process 700 may involve processor 512 performing receiving processing for one or more codeblocks in the PDSCH transmission including by performing de-interleaving on a result from a channel interleaver and/or from an intra-codeblock interleaver that performs pseudo-random interleaving on systematic bits and parity bits of the one or more codeblocks and channel decoding. Process 700 may proceed from 720 to 730.

At 730, process 700 may involve processor 512 transmitting, via transceiver 516 and to apparatus 520, a feedback reporting a result of the receive processing.

In some implementations, the intra-codeblock interleaver may include a block interleaver or a turbo-block interleaver.

In some implementations, the channel interleaver may include a rectangular block interleaver with a unit of resource block bundle. Moreover, write-in of the channel interleaver may follow one dimension and read-out of the channel interleaver may follow another dimension.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a Physical Downlink Shared Channel (PDSCH) transmission from a network node of a wireless network; mapping, by the processor, one or more codeblocks of a codeword in the PDSCH transmission to a spatial layer group which is a subset of a plurality of spatial layers; and
transmitting, by the processor, to the network node a feedback concerning the one or more codeblocks.

2. The method of claim 1, wherein the feedback comprises a hybrid automatic repeat request (HARQ) feedback with multiple bits indicating a plurality of states including at least an error state.

3. The method of claim 2, wherein the error state indicates to the network node that all codeblocks or all codeblock groups on one or more specific spatial layers of the plurality of spatial layers have been received in error.

4. The method of claim 1, wherein the mapping of the codeblock further comprises:
aligning the spatial layer group to one or more interfering signals with one or more other spatial layer groups of the plurality of spatial layers orthogonal to the one or more interfering signals.

5. The method of claim 1, further comprising:
utilizing, by the processor, a first interference measurement resource (IMR) in receiving a non-zero power (NZP) channel state information reference signal (CSI-RS) from the network node in a presence of a cross-link interference (CLI);
utilizing, by the processor, a second IMR in receiving the NZP CSI-RS from the network node in an absence of the CLI;
generating, by the processor, a first precoding matrix indicator (PMI) and a first rank indicator (RI) in an event that the first IMR is utilized;
generating, by the processor, a second PMI and a second RI in an event that the second IMR is utilized; and
transmitting, by the processor, to the network node a feedback including either the first PMI and the first RI or the second PMI and the second RI, or both.

6. The method of claim 5, wherein the generating of the first PMI, the second PMI, the first RI and the second RI is based on Type I single-panel codebook, Type I multi-panel codebook, Type II codebook, or Type II port-selection codebook defined in New Radio (NR).

7. The method of claim 1, further comprising:
utilizing, by the processor, a first process associated with a first interference measurement resource (IMR) in receiving a non-zero power (NZP) channel state information reference signal (CSI-RS) from the network node in a presence of a heavy cross-link interference (CLI);
utilizing, by the processor, a second process associated with a second IMR in receiving the NZP CSI-RS from the network node in a presence of a light CLI;
generating, by the processor using the first process, a first codeword mapped to a first group of spatial layers as well as a second codeword mapped to a second group of spatial layers not overlapping with the first group;
generating, by the processor using the second process, the first codeword mapped to the first group of spatial layers and any spatial layer not in the second group as well as the second codeword mapped to the second group of spatial layers and any spatial layer not in the first; and
transmitting, by the processor, to the network node a feedback associated with the first codeword and the second codeword.

8. The method of claim 1, further comprising:
selecting, by the processor and according to a control signaling from the network node, a first subset of one or more spatial layers mapped to a first codeword and a second subset of one or more spatial layers from the plurality of spatial layers mapped to a second codeword.

9. The method of claim 8, wherein the selecting of the first subset of one or more spatial layers comprises separating the plurality of spatial layers into the first subset of one or more spatial layers and the second subset of one or more spatial layers, wherein the first subset and the second subset are contiguous in a spatial domain.

10. The method of claim 1, further comprising:
pairing, by the processor, every two spatial layers of the plurality of spatial layers to form a set of pairs of spatial layers; and
selecting, by the processor and according to a control signaling from the network node, a first subset of one or more pairs from the set of pairs for a first codeword and a second subset of one or more pairs from the set of pairs for a second codeword, wherein the control signaling indicates that the first subset of one or more pairs of spatial layers is mapped to the first codeword and that a second subset of one or more pairs of spatial layers from the set of pairs is mapped to a second codeword.

11. The method of claim 1, further comprising:
partitioning, by the processor, each codeblock of the one or more codeblocks into a plurality of segments each having a size of m·n with m rows and n columns; and
applying, by the processor, an interleaving operation on each segment of the plurality of segments.

12. The method of claim 11, further comprising:
prior to the partitioning, determining, by the processor, a size of an interleaver that performs the interleaving operation to control a region in which each a respective codeblock of the one or more codeblocks is spread out to thereby control a diversity level and latency,
wherein the respective codeblock is transmitted across multiple orthogonal frequency-division multiplexing (OFDM) symbols.

13. The method of claim 11, further comprising:
prior to the partitioning, determining, by the processor, a value of each of m and n to control how a respective codeblock of the one or more codeblocks is distributed in a m·n block.

14. The method of claim 1, wherein the PDSCH spans over a plurality of physical resource block (PRB) bundles, wherein each PRB bundle comprises respective multiple PRBs, and wherein the interleaving is performed over the plurality of PRB bundles with each PRB bundle of the plurality of PRB bundles being an individual interleaving unit.

15. A method, comprising:
receiving, by a processor of a user equipment (UE), a Physical Downlink Shared Channel (PDSCH) transmission from a network node;
performing, by the processor, receive processing for one or more codeblocks in the PDSCH transmission including by performing de-interleaving on a result from a channel interleaver or from an intra-codeblock interleaver that performs pseudo-random interleaving on systematic bits and parity bits of the one or more codeblocks and channel decoding; and
transmitting, by the processor, to the network node a feedback reporting a result of the receive processing.

16. The method of claim 15, wherein the intra-codeblock interleaver comprises a block interleaver or a turbo-block interleaver.

17. An apparatus, comprising:
a transceiver capable of wirelessly communicating with a network node of a wireless network; and
a processor communicatively coupled to the transceiver, the processor capable of:
receiving, via the transceiver, a Physical Downlink Shared Channel (PDSCH) transmission from the network node;
mapping one or more codeblocks of a codeword in the PDSCH transmission to some but not all spatial layers of a plurality of spatial layers; and
transmitting, via the transceiver, to the network node over one or more orthogonal frequency-division multiplexing (OFDM) symbols a feedback comprising the codeblock and reporting a result of the channel estimation.

18. The apparatus of claim 17, wherein the feedback comprises a hybrid automatic repeat request (HARQ) feedback with multiple bits indicating a plurality of states including at least an error state, and wherein the error state indicates to the network node that all codeblocks or all codeblock groups on one or more specific spatial layers of the plurality of spatial layers have been received in error.

19. An apparatus, comprising:
a transceiver capable of wirelessly communicating with a network node of a wireless network; and
a processor communicatively coupled to the transceiver, the processor capable of:
receiving, via the transceiver, a Physical Downlink Shared Channel (PDSCH) transmission from a network node;
performing receive processing for one or more codeblocks in the PDSCH transmission including by performing de-interleaving on a result from a channel interleaver or from an intra-codeblock interleaver that performs pseudo-random interleaving on systematic bits and parity bits of the one or more codeblocks and channel decoding; and
transmitting, via the transceiver, to the network node a feedback reporting a result of the receive processing.

20. The apparatus of claim 19, wherein the channel interleaver comprises a rectangular block interleaver with a unit of resource block bundle, wherein write-in of the channel interleaver follows one dimension and read-out of the channel interleaver follows another dimension.
